(19) United States
(12) Patent Application Publication
(10) Pub. No.: US 2009/0265668 A1
(43) Pub. Date: Oct. 22, 2009

(54) 3D INPUT/NAVIGATION DEVICE WITH FREEZE AND RESUME FUNCTION

(75) Inventors: Norbert Christiaan Esser, San Jose, CA (US); Paulus Mathias Hubertus Mechtildis Antonius Gorissen, Eindhoven (NL); Whilhelmus Petrus Adrianus Johannus Michiels, Eindhoven (NL); Jurjen Pieter Pauw, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/298,957

(22) PCT Filed: Apr. 25, 2007
(86) PCT No.: PCT/IB07/51523

§ 371 Date: Oct. 29, 2008

(30) Foreign Application Priority Data
May 2, 2006 (EP) 06113367.4

(51) Int. Cl. G06F 3/048

(52) U.S. Cl. 715/850

(57) ABSTRACT

3D input/navigation device, method and computer program product for controlling an object in a three-dimensional space by an operator, wherein an object can be switched in a frozen condition in which the movements of the object are suppressed with respect to at least one direction such that the object can only be moved in a surface or along a line determined by the operator and can be switched in a released condition in which the object is resumed or released such that it is freely controllable corresponding to a relative position of the device in a reference system.

### FIELD OF THE INVENTION

The present invention relates generally to a 3D input/navigation device, and more particularly to a 3D input/navigation device having enhanced operability. Such a 3D input/navigation device finds particular application in the medical domain where physicians or other medical specialists often look at three-dimensional images and three-dimensional structures, respectively, represented on a display. The medical specialist has to navigate in the three-dimensional image and control object(s), respectively, therein. However, it should be appreciated that the present invention may also find application, for example, in the architecture, aerospace and mechanical engineering domain as well as in the field of entertainment, e.g. computer games or virtual worlds.

### DESCRIPTION OF THE PRIOR ART

In the above mentioned domains people more and more operate in three-dimensional spaces and with three-dimensional objects represented on a display or directly viewable by an operator. There is an enormous plurality of different 3D input/navigation devices which are able to generate data with respect to its positions and/or orientations and to enter these data into a computer system in order to control objects in a three-dimensional space represented on a display.

EP 0 526 015 A1 issued to Shenholz and entitled “Three-dimensional computer mouse” describes one of such 3D input devices. This document discloses a three-dimensional mouse system for a computer's display, or a robot, comprising a pointer movable in space by the user, a transmitter being an integral part of the pointer, at least three receivers, a processing unit having a microprocessor, an input/output communication interface and a connecting unit for information and power transfer and a software means. When the receivers react to a signal received from the transmitter, they transfer independently to the microprocessor their output signals, depending correspondingly on the space position of the transmitter with reference to the receivers and the microprocessor computes the space position of the transmitter and the output signal of the microprocessor is transformed into an appropriate form and is then transferred to the computer and processed by the software means to provide on the computer's display or in the robot's action a three-dimensional reflection, corresponding to the movement of the pointer, in real time, in space.

Navigating and controlling using 3D input/navigation devices which are freely movable in space for controlling an object and navigating in three-dimensional space has specific disadvantages. For example, a high precision navigation and controlling which is often necessary, especially in the medical, aeronautics or mechanical engineering domain, is not possible with conventional 3d input/navigation devices since an unintended movement of the arm or the hand of the operator, for example a trembling or an unintended movement due to exhaustion or insufficient concentration of the operator, leads to an unintended movement of the controlled object. Furthermore, it is often necessary or at least helpful to navigate and control along a specific line or within a specific surface.

Further, if an operator has navigated with a conventional 3d input/navigation device to a certain position “A” in the 3D image and wishes to navigate even further, but his or her arm is already fully extended, the operator can not only readjust his/her arm, i.e. position it in an appropriate position, and thereupon continue navigation and controlling starting from the aforementioned position “A” since the readjusting movement of the arm would also lead to a movement of the controlled object which is not desired. This is in particular a problem of 3D input/navigation devices, since conventional 2D mice can be lifted up and placed somewhere else without substantial change of the position of the controlled object, though minor shifting being generally undesirable occurs.

### SUMMARY OF THE INVENTION

It is an object of the present invention to provide a 3D input/navigation device, a method and a computer program product which further improves navigating in a three-dimensional space and controlling of object(s) therein.

According to the present invention, the object is achieved by a 3D input/navigation device with the features of claim 1, a method with the features of claim 14 and a computer program product with the features of claim 18. Preferred embodiments are defined in the respective dependent claims.

An advantage of the present invention is the high precision navigating and controlling of an object displayed on a display or directly viewable by the operator.

A further advantage of the present invention is the improved ease of operation.

According to one aspect the invention is directed to a 3D input/navigation device for controlling an object in a three-dimensional space by an operator, wherein the device can be operatively coupled to a computer system, wherein a data generator being provided operative to generate data in response to the relative position of the device in a reference system and operative to output the data to the computer system, wherein the device is able to switch the object in a frozen condition in which the movements of the object are suppressed with respect to at least one direction such that the object can only be moved in a surface or along a line determined by the operator and to switch the object in a resumed, released or unfrozen condition in which the object is released such that it is freely controllable corresponding to a relative position of the device in the reference system. The surface can be a plane, a curved surface, a straight line, a curved line or any other kinds of surfaces and lines.

The freezing and suppressing, respectively, is achieved in that the output generator outputs data with at least one frozen coordinate concerning positions and/or orientations. In this way, defined movements concerning lines and surfaces which are parallel to the coordinate system (three axes, often X, Y, Z, which are orthogonal to each other) are possible. However, it is also possible that the freezing or suppressing is achieved in that an output of the 3D input/navigation device causes a computer program executed by the computer system to freeze or suppress specific, i.e. determined or predetermined, movements of the controlled object. It is further possible, prior to the controlling or navigating, to input and store surfaces, lines and/or orientations which are defined by an operator by means of the computer system and access to these predefined surfaces, lines and/or orientations by activating with the 3D input/navigation device such that a navigating and controlling is possible only with respect to the predeterminations. Surfaces, lines and/or orientations can be defined, for example, in form of mathematical functions. In this way, also complex surfaces and lines can be defined. The 3D input/navigation device can be used for selecting a predefined surface, line and/or orientation from a menu displayable on a monitor upon requesting by an operator.

In light of the above, a high precision controlling is achieved as it is possible to navigate the object with respect to (pre)determined surfaces, lines and orientations.

The arrangement is able to provide data in response to control movements carried out with a 3D input/navigation device by a hand or arm or other position changing of an operator. It is to be understood that there are a plurality of arrangements known in the prior art for providing data (x, y, z; φ, ψ, θ and/or Δx, Δy, Δz; Δφ, Δψ, Δθ) to control objects based on respective positions/movements of a 3D input/navigation device in a reference system. Possibilities for detecting and determining movements and/or positions of 3D input/navigation devices can be based on translational acceleration, position sensing or detecting arrangements, transmitters, receivers, RF signals, ultrasonic sound signals, amplifiers, distance measurements, light sources and corresponding shadow courses, etc, and corresponding devices operatively coupled to a computer system and/or a 3D input/navigation device.

The reference system is the space in which the 3D input/navigation device is moved for controlling the object. Depending on the arrangement, the reference system could be a “fixed” reference system which is sensed and detected by corresponding 3D input/navigation device position detecting arrangements.

In this respect, a data generator within the 3D input/navigation device can be adapted to generate data in response to positions/movements of the 3D input/navigation device, for example, by means of translational acceleration. However, the data generator could also be a means outside of the 3D input/navigation device that processes and outputs data detected for determining the positions/movements of a 3D input/navigation device, for example, by means of respective position detecting arrangements.

The 3D input/navigation device according to a preferred embodiment is able, upon activation by the operator, to switch the object in a completely frozen condition in which the object is frozen with respect to its current position and/or orientation and to switch the object in a released condition in which the object is released such that it is controllable starting from its exact prior frozen position.

The completely freezing can be achieved in different ways. For example, the data generator could be configured for not outputting data at all. However, it is also possible that the operative coupling between the computer system and the 3D input/navigation device is interrupted during the frozen state. Further, it is also possible that the completely freezing is achieved in that an output of the 3D input/navigation device causes a program running on the computer system to freeze the current position and/or orientation. Depending on the system in which the 3D input/navigation device is used it is also possible that the 3D input/navigation device switches respective position detecting means in an “off-state” for freezing the object and switches them in an “on-state” for resuming the object.

Accordingly, the 3D input/navigation device of the present invention enables an operator to relax, recreate and, in particular, readjust or reposition his/her arm without causing an unintended movement of the controlled object by completely freezing the object. After readjusting, the operator is able, subsequently to the resuming, to continue controlling starting from the completely frozen position/orientation. Accordingly, not only the precision but also the ease of operation is improved.

Further, the 3D input/navigation device of the present invention can be equipped with at least one actuation means with which the freezing and resuming, i.e. the switching operation, can be activated. The actuation means could be buttons, control levers or sliders, or any other kinds of activating or deactivating means. It is to be understood that the 3D input/navigation device could be equipped with additional functional means.

However the switching could also be activated via voice control. In this case, the 3D input/navigation device would be equipped with a receiver(s) and appropriate electronics.

The 3D input/navigation device could also be equipped with an orientation control means, e.g. a track ball, a control lever, control buttons, angular velocity detectors, scrolling means, etc. operative to generate data in response to the orientation control movement (depending on the construction: pushing, pulling, tilting, scrolling, rotating, etc.) carried out by the operator.

The 3D input/navigation device according to the present invention can be operatively coupled to the computer system wireless, e.g. via radio communication, and/or by means of cable(s). It is also possible that the 3D input/navigation device and the computer system, respectively, are operatively coupled to the object via a network, e.g. the Internet. Therefore, the present invention could be used, for example, in remote operations.

In another embodiment of the present invention the 3D input/navigation device can be freely moved in space for controlling an object. However, it is also possible that the 3D input/navigation device is located on a substantially horizontal plane during controlling and navigating with respect to two dimensions and orientations, respectively, wherein the 3D input/navigation device is moved up or down for controlling and navigating in the three-dimensional image with respect to the third dimension.

Further, the data generator is able to provide data concerning absolute positions and/or orientations (x, y, z; φ, ψ, θ) and/or data concerning relative positions and/or orientations (Δx, Δy, Δz; Δφ, Δψ, Δθ) depending on the position determining arrangement.

A particular implementation of the method of the invention comprises the steps of:

switching the object in a completely frozen condition in which the object is frozen with respect to its current position and/or orientation; and

switching the object in a released condition in which the object is released such that it is controllable starting from its frozen condition.

A particular example of an implementation of the invention comprises the steps of:

predefining surfaces in which the object is to be controlled and/or lines along which the object is to be controlled and/or orientations in which the object is to be oriented;

inputting them into a computer system;

selecting a surface and/or line and/or orientation from a menu, displayable on a display, by means of the device, e.g. the step of controlling orientations of the object is incorporated.

A more complete appreciation of the invention and many of the attended advantages and aspects thereof will be readily obtained as the same becomes understood by reference to the following detailed description when considered in conjunction with the accompanying drawings, wherein:

### BRIEF DESCRIPTION OF THE DRAWINGS

FIG. 1 is a schematic perspective illustration of an operator, a computer system and a receiver as well as a 3D input/navigation device according to a first embodiment of the present invention.

FIG. 2 is a schematic perspective illustration of a three-dimensional space displayed on a display according to the first embodiment of the present invention.

FIG. 3 is a simplified flow chart of a controlling procedure according to a second embodiment of the present invention.

FIG. 4 is a simplified flow chart of a controlling procedure according to a third embodiment of the present invention.

### DETAILED DESCRIPTION OF THE PREFERRED EMBODIMENTS

Selected embodiments of the present invention will now be described with reference to the drawings. It is to be understood that the following description of the embodiments of the present invention are provided for illustration only and not for the purpose of limiting the invention as defined by the appended claims and their equivalents.

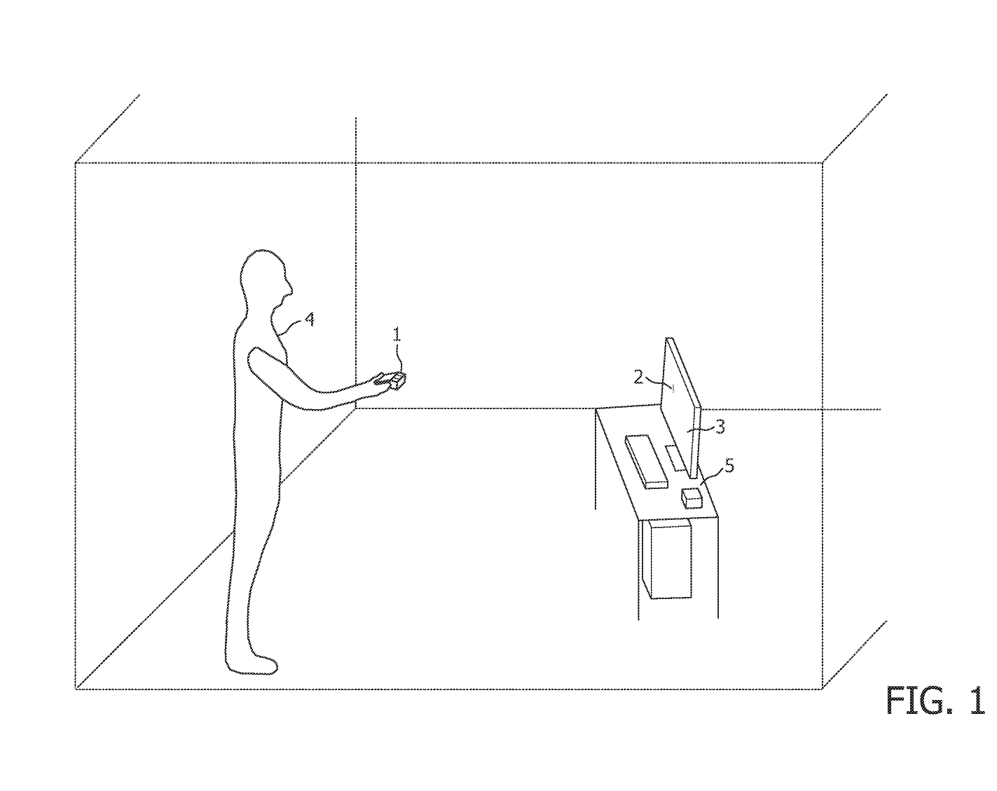

FIG. 1 shows a first embodiment of the present invention. A 3D input/navigation device 1 (hereinafter referred as 3D control device) is located within a reference system schematically shown by the dashed lines. The reference system is the space in which the 3D control device is moved. The 3D control device 1 is manipulated by an operator 4 and is operatively coupled to a computer system for controlling an object 2 displayed on a monitor or display 3. The computer system includes amongst other things the display 3, a central processing unit, input/output interfaces, a random access memory, a read-only memory, control circuits, an input means (e.g. a keyboard), computer programs, etc.

A computer program is installed on the computer system which is able to process the data and instructions from the 3D control device 1. It is to be understood that a computer program already known in the prior art can be upgraded or updated in such a manner that it is able to work with the present 3D control device 1.

For controlling the object 2 according to relative movements of the 3D control device 1, it is necessary to determine the positions/movements of the 3D control device 1 in the reference system. For this purpose a data generator operative to generate data in response to movements/positions of the 3D control device 1 in the reference system is integrated within the 3D control device 1. In the first embodiment the 3D control device 1 uses acceleration detection means for determining the movements/positions of the 3D control device 1.

Further, a receiver 5 is arranged for detecting the outputs from the data generator. It will be apparent to those skilled in the art that respective electronics, e.g. a transmitter, are arranged in the 3D control device 1 for operative coupling to the receiver 5. The receiver 5 is operatively coupled to the 3D control device 1 and the computer system and provides data to the computer system with which the navigation of the object 2 can be carried out. The 3D control device 1 is wireless operatively coupled to the receiver 5 such that a free and unrestricted movement of the 3D control device 1 is possible in comparison to the case in which it is connected via cable to the computer system.

Further, the 3D control device 1 is equipped with at least one orientation control means, for example a track ball, a control lever, control buttons, angular velocity detectors, scrolling means, etc., operative to generate data in response to the orientation control movement (depending on the construction, pushing, pulling, tilting, etc.) carried out by the operator 4. The generated data concerning positions and orientations are provided to the computer system and processed by a corresponding computer program executable by the computer system.

The arrangement described above is able to provide data in response to control movements carried out with a 3D control device in a reference system by a hand and/or the arm of an operator. It is to be understood that the data can be absolute data (x, y, z; φ, ψ, θ) as well as relative data (Δx, Δy, Δz; Δφ, Δψ, Δθ). Further, it is to be understood that the arrangement described above is only one of a plurality of arrangements known in the prior art for providing data (x, y, z; φ, ψ, θ and/or Δx, Δy, Δz; Δφ, Δψ, Δθ) in order to control objects based on respective positions/movements of a 3D control device in a (fixed) reference system.

Possibilities for detecting and determining movements and/or positions of 3D control devices can be based on translational acceleration detection, transmitters, receivers, position detecting arrangements (detecting of 3D control device positions with detectors) and amplifiers based on RF signals, ultrasonic sound signals, distance measurements, light sources and corresponding shadow courses, etc, wherein the respective devices are operatively coupled to the 3D control device and the computer system.

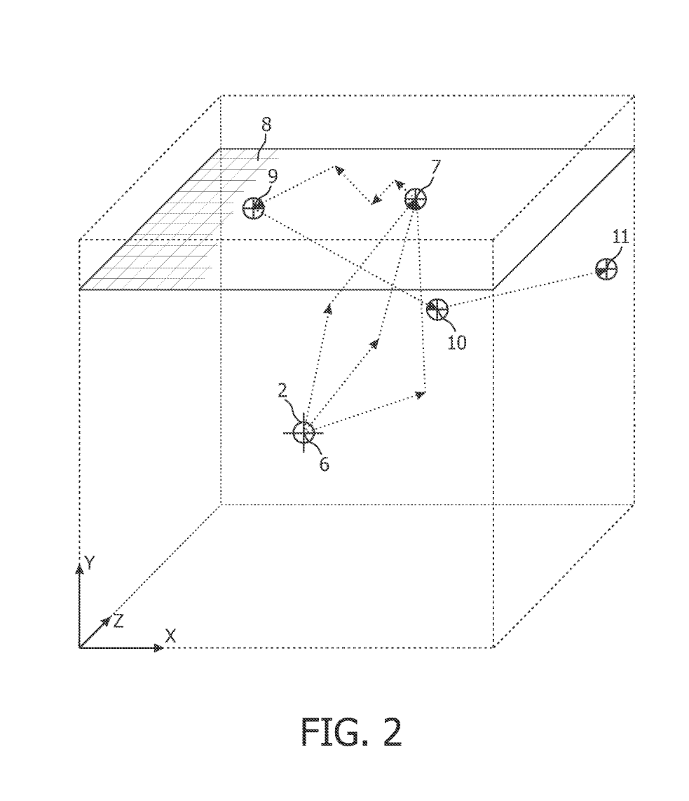

Referring again to FIG. 1, the 3D control device 1 is able to switch the object 2 in a frozen condition in which the movements of the object 2 are suppressed or prevented with respect to at least one direction such that the object 2 can only be moved in a surface or along a line determined by the operator 4 and to switch the object 2 in a released, resumed or unfrozen condition in which the object 2 is released such that it is freely controllable corresponding to a relative position/movement of the 3D control device 1 in the reference system. This function is described in further detail in FIG. 2.

FIG. 2 shows a three-dimensional image displayed on the display 3 (not shown). Reference sign 2 illustrates an exemplified object to be controlled or navigated, 7 illustrates a first target position to which the operator 4 wants to navigate and 8 illustrates a surface in which the operator 4 wants to navigate for certain reasons depending on the respective circumstances. The operator 4 can control the object 2 by corresponding relative movements of his arm from the start position 6 to the first target position 7, wherein a plurality of different ways are possible to come to the first target position 7, as shown by the dotted lines between the start position 6 and the first target position 7. When the object 2 has reached the first target position 7, the operator 4 wants to suppress or prevent any movements of the object 2 in direction Y.

For this reason, the operator 4 actuates a button or any other switching means arranged on the 3D control device 1. The button is operatively coupled to the data generator and causes the data generator to freeze the Y direction. This means, when the operator 4 moves up his arm in direction Y after freezing direction Y, the data generator outputs an unchanged, i.e. a frozen, y-coordinate that is in the present example the y-coordinate of the first target position 7 (the first target position 7 is located within the surface 8). During controlling the object 2 with a frozen y-coordinate, the data generator outputs data with a frozen y-coordinate together with changeable coordinates concerning the remaining coordinates and orientations (“5 degrees of freedom”).

After having navigated in the surface 8 a certain time, as shown by the dotted lines between the first target position 7 and a second target position 9, the operator 4 wants to navigate to a third target position 10 outside the surface 8. Consequently, the operator 4 has to switch the object 2 in a resumed, released or unfrozen condition in which the object 2 is released such that it is freely controllable to the third target position 10. For this purpose the operator 4 actuates the same button which has been actuated for freezing the y-coordinate (or alternatively another button for activating resuming) which causes releasing or resuming the y-coordinate. Therefore, the data generator outputs data corresponding to the control movements of the operator 4 with a changeable y-coordinate (“6 degrees of freedom”). It is to be understood that surfaces and lines which are parallel to the three-dimensional axes X, Y, Z can be defined as follows:

Horizontal surface (parallel to x/z-surface): freezing a Y-coordinate

Vertical surface (parallel to y/z-surface): freezing a X-coordinate

Vertical surface (parallel to x-y-surface): freezing a Z-coordinate

In the first embodiment there is no need for a specific orientation or a changing of the orientation of the object 2. However, it is to be understood that rotations, i.e. changing or adapting of the orientation of the object 2, about straight lines which are parallel to the three-dimensional axes X, Y, Z can be defined as follows:

Rotations about a straight line parallel to axis X: freezing ψ, θ-coordinates

Rotations about a straight line parallel to axis Y: freezing φ, θ-coordinates

Rotations about a straight line parallel to axis Z: freezing φ, ψ-coordinates

In the first embodiment the operator 4 has only wished to suppress movements which were parallel to the Y axis which consequently leads to a surface that is parallel to the X/Z surface.

However, even curved or declined surfaces and lines, or any other kinds of lines or surfaces as well as various orientations are definable with the present invention. For this purpose the operator can program respective surfaces and lines, for example mathematical functions, input them in a computer program executable on the computer system and access to these predetermined surfaces, lines and orientations via corresponding outputs of the 3D control device handled by an operator. For example a menu can be appeared on the display upon activation by an operator from which specific predetermined surfaces, lines and orientations can be selected.

Upon arriving third target position 10 at which the arm of the operator 4 is fully extended the operator 4 has to navigate to a fourth target position 11. To navigate to the fourth target position 11 the operator 4 manipulates the 3D control device 1 to switch the object 2 in a completely frozen condition in which the object 2 is frozen with respect to its current position and/or orientation, i.e. the third target position 10 in the first embodiment. In the first embodiment the “completely” freezing is performed in such a manner that the data generator freezes all coordinates concerning positions and orientations.

Subsequent to the freezing the operator 4 readjusts himself which means in the first embodiment a movement of his arm towards his body. After readjusting the operator 4 manipulates the 3D control device 1 to switch the object 2 in a released condition in which the object 2 is released such that is controllable starting from its frozen position, i.e. third target position 10, to the third target position 11.

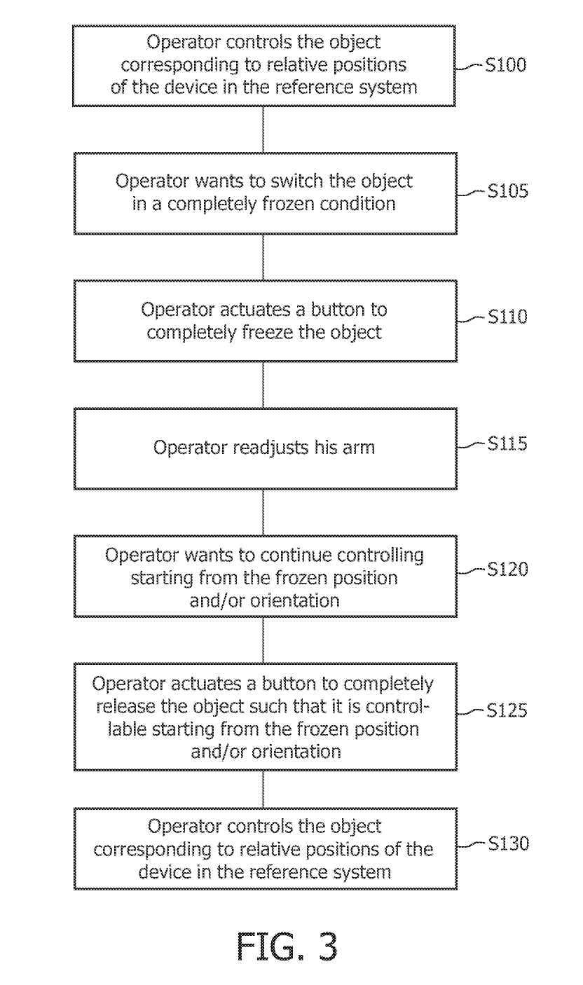

FIG. 3 is a simplified flow chart in which the essential steps of a second embodiment of the present invention are illustrated. The method steps in the second embodiment are carried out in an arrangement substantially described in the first embodiment. Therefore, the same reference signs as in the first embodiment are used.

In step S100 an operator 4 controls an object 2 displayed on a display 3 corresponding to relative positions of the 3D control device 1 in the reference system. In step S105 the operator 4 wants to switch the object 2 in a completely frozen condition with respect to its current position and/or orientation. In step S110 the operator 4 actuates a button at the 3D control device 1 in order to completely freeze the object 2. In step S115 the operator 4 readjusts his arm and/or repositions himself and/or takes any other activities. In step S120 the operator 4 wants to continue the controlling starting from the frozen position and/or orientation. Therefore, the operator 4 actuates in step S125 a button at the 3D control device 1 in order to release the object 2 such that it is controllable starting from the frozen position and/or orientation. Thereupon, in step S130 the operator 4 is able to control the object 2 corresponding to the movements or relative positions, respectively, of the 3D control device 1 in the reference system.

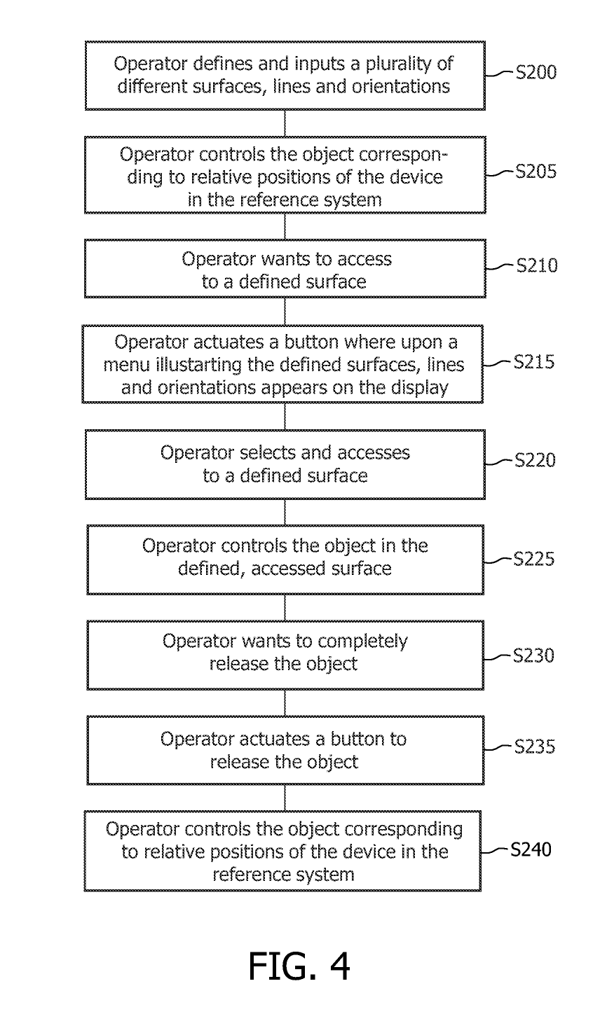

FIG. 4 is a simplified flow chart in which the essential steps of a third embodiment of the present invention are illustrated. The method steps in the third embodiment are carried out in the arrangement described with respect to the first embodiment. Therefore, the same reference signs as in the first embodiment are used.

In step S200 an operator 4 defines and inputs a plurality of different surfaces, lines and orientations, depending on the present circumstances, in or along which an object 2 displayable on a display 3 is to be controlled. Thereupon, the operator 4 controls in step S205 the object 2 corresponding to the relative position of the 3D control device 1 in the reference system without limitations. In step S210 the operator 4 wants to access to a defined surface. In step S215 the operator 4 actuates a button at the 3D control device 1 whereupon a menu illustrating the plurality of defined surfaces, lines and orientations appears on the display 3. In step S220 the operator 4 selects and accesses to a defined surface by means of the 3D control device 1. In step S225 the operator 4 controls the object 2 in the defined, accessed surface. In step S230 the operator 4 wants to release the object 2 such that it is freely controllable without any limitations. Therefore, the operator 4 actuates in step S235 a button at the 3D control device 1 in order to release the object 2 such that it is freely controllable. Thereupon, in step S240 the operator 4 is able to control the object 2 corresponding to the movements or relative positions, respectively, of the 3D control device 1 in the reference system.

While only preferred embodiments have been chosen to illustrate the core of the present invention, it will be apparent to those skilled in the art from this disclosure that various changes and modifications can be made herein without departing from the scope of the invention as defined in the appended claims.

For example, it could be possible that the object is not displayed on a monitor but rather direct viewable by the operator.

Further, in specific circumstances it is necessary to precisely align or orient an object. However, such an aligning is often very difficult since an operator has to hold her/his arm absolutely unmovable or fixed which is in practice hardly possible. Although, the arm of the operator possibly trembles, the operator is nevertheless able to precisely align the object in a desired direction or orientation as the object can be frozen with respect to a certain position from which the object is oriented.

The arrangement described in the aforementioned embodiment provides data concerning positions/movements using acceleration detecting means. However, it should be appreciate for people skilled in the art that there are a plurality of different possibilities for determination and detection of positions, translational movements and/or rotary movements of a 3D mouse.

As already mentioned above, while embodiments of the present invention have been described herein for purposes of illustration, many modifications and changes will become apparent to those skilled in the art. Accordingly, various changes and modifications can be made herein without departing from the scope of the invention as defined in the appended claims. A Computer program product is to be understood to mean any software product capable of being stored on a computer-readable medium, downloadable via a network, such as the Internet, or available or marketable in any other manner.

1. 3D input/navigation device for controlling an object (2) in a three-dimensional space by an operator (4), wherein the device (1) can be operatively coupled to a computer system, wherein a data generator being provided operative to generate data in response to the relative position of the device (1) in a reference system and being operative to output the data to the computer system, wherein the device (1) is able to switch the object (2) in a frozen condition in which the movements of the object (2) are suppressed with respect to at least one direction such that the object (2) can only be moved in a surface or along a line determined by the operator (4) and to switch the object (2) in a released condition in which the object (2) is released such that it is freely controllable corresponding to a relative position of the device (1) in the reference system.

2. 3D input/navigation device according to claim 1, wherein the device (1) is able to switch the object (2) in a completely frozen condition in which the object (2) is frozen with respect to its current position and/or orientation and to switch the object (2) in a released condition in which the object (2) is released such that it is controllable starting from its frozen condition.

3. 3D input/navigation device according to claim 1, wherein the device (1) is adapted to call up a menu, displayable on a display (3), from which predetermined surfaces, lines and orientations can be accessed.

4. 3D input/navigation device according to 1, wherein the switching operation is activated via at least one actuation means arranged on the device (1).

5. 3D input/navigation device according to claim 1, wherein at least one means for controlling orientation of the object (2) is arranged at the device (1).

6. 3D input/navigation device according to claim 1, wherein the freezing and resuming is activated via voice control.

7. 3D input/navigation device according to claim 1, wherein the device (1) is wireless operatively coupled to the computer system.

8. 3D input/navigation device according to claim 1, wherein the device (1) is operatively coupled to the computer system via at least one wire.

9. 3D input/navigation device according to claim 1, wherein the device (1) and the computer system are operatively coupled to the object (2) via network.

10. 3D input/navigation device according to claim 1, wherein the device (1) is freely movable in space by the operator (4) for controlling the object (2).

11. 3D input/navigation device according to claim 1, wherein the device (1) is capable of being located on a substantially horizontal plane during controlling the object (2) in a plane parallel to a horizontal surface (X/Z surface) and is moved up and down only for controlling with respect to a direction (Y) substantially perpendicular to the plane.

12. 3D input/navigation device according to claim 1, wherein the data generator is adapted to provide data concerning absolute positions and/or orientations (x, y, z; φ, ψ, θ) and/or data concerning relative positions and/or orientations (Δx, Δy, Δz; Δφ, Δψ, φθ).

13. 3D input/navigation device according to claim 1, wherein the data generator is arranged inside of the device (1) and is operatively coupled to the computer system.

14. Method for controlling an object (2) in a three-dimensional space by an operator (4), wherein a 3D input/navigation device (1) can be operatively coupled to a computer system, wherein a data generator being provided operative to generate data in response to the relative position of the device (1) in a reference system and operative to output the data to the computer system, comprising the steps of:
controlling the object (2) corresponding to movements of the device (1) in the reference system;
switching the object (2) in a frozen condition in which the movements of the object (2) are suppressed with respect to at least one direction such that the object (2) can only be moved in a surface or along a line determined by the operator (4); and
switching the object (2) in a released condition in which the object (2) is released such that it is freely controllable corresponding to a relative position of the device (1) in the reference system.

15. Computer program product, adapted for carrying out the method steps of controlling an object (2) in a three-dimensional space by an operator (4), wherein a 3D input/navigation device (1) can be operatively coupled to a computer system, wherein a data generator being provided operative to generate data in response to the relative position of the device (1) in a reference system and operative to output the data to the computer system, comprising the steps of:
controlling the object (2) corresponding to movements of the device (1) in the reference system;
switching the object (2) in a frozen condition in which the movements of the object (2) are suppressed with respect to at least one direction such that the object (2) can only be moved in a surface or along a line determined by the operator (4); and
switching the object (2) in a released condition in which the object (2) is released such that it is freely controllable corresponding to a relative position of the device (1) in the reference system.

16. Computer program product according to claim 15, wherein the product is in the form of a software package adapted to upgrade or update a computer program executable on a computer system.
